(19) United States
(12) Patent Application Publication
(10) Pub. No.: US 2025/0252371 A1
(43) Pub. Date: Aug. 7, 2025

(54) MANUFACTURING SCHEDULING BASED ON REWARD REWEIGHTING

(71) Applicant: Samsung Display Co., Ltd., Yongin-si (KR)

(72) Inventors: Shuhui Qu, Fremont, CA (US); Janghwan Lee, Pleasanton, CA (US); Kasra Yazdani, San Jose, CA (US)

(21) Appl. No.: 18/625,599

(22) Filed: Apr. 3, 2024

Related U.S. Application Data
(60) Provisional application No. 63/550,891, filed on Feb. 7, 2024.

(51) Int. Cl. G06Q 10/0631; G06N 20/00; G06Q 50/04

(52) U.S. Cl. CPC G06Q 10/06312; G06N 20/00; G06Q 50/04

(57) ABSTRACT

Provided is a system and a method for scheduling. The method includes training a first scheduling policy based on a first weight and training a second scheduling policy based on a second weight that is different from the first weight, calculating a first evaluation result based on the first scheduling policy, calculating a second evaluation result based on the second scheduling policy, determining, by a processing circuit, a third scheduling policy based on inputting the first evaluation result and the second evaluation result into a policy-combination algorithm, calculating a third evaluation result based on the third scheduling policy, based on the third evaluation result, determining a third weight for the third scheduling policy by inverse reinforcement learning or by Bayesian optimization, training the third scheduling policy based on the third weight, and controlling a scheduling process based on the third scheduling policy.

### CROSS-REFERENCE TO RELATED APPLICATION

This application claims the priority benefit under 35 U.S.C. § 119(e) of U.S. Provisional Application No. 63/550,891, filed on Feb. 7, 2024, the disclosure of which is incorporated by reference in its entirety as if fully set forth herein.

### TECHNICAL FIELD

The disclosure generally relates to manufacturing systems and methods. More particularly, the subject matter disclosed herein relates to improvements to manufacturing scheduling based on reward reweighting.

### SUMMARY

Manufacturing facilities may face the challenge of efficiently producing a diverse range of products. For example, a number of product lots (e.g., product types) may be in a range of hundreds of thousands. Each product lot may undergo numerous processes across multiple machines. Efficient coordination of the machines, products, resources, and/or the like of a manufacturing system is important for achieving higher productivity and utilization. Experts with extensive domain expertise and years of training may be able to produce reasonable manufacturing scheduling policies. However, adapting existing scheduling policies to changing evaluation criteria (e.g., evaluation metrics) based on human experience and expertise alone may be inadequate to meet modern evolving evaluation metrics. As used herein, the terms “evaluation criteria” and “evaluation metrics” refer to both qualitative evaluation information and quantitative evaluation information.

Reinforcement learning (RL) may be used to help determine improved scheduling. A manufacturing facility may employ a set of evaluation metrics to assess schedule quality (e.g., performance) by computing the weighted sum of the set of evaluation metrics. However, it may be difficult to integrate (e.g., to directly integrate) some of the evaluation metrics into the optimization process of RL. Additionally, with so many product lots and differing evaluation metrics, efficiently searching for optimal weight combinations may be a central challenge to achieving satisfactory scheduling performance and aligning the capabilities of manufacturing systems with evolving factory objectives.

Aspects of some embodiments of the present disclosure provide for a proxy-stage reward system that may be used to integrate the evaluation metrics into the optimization process of RL. In some embodiments, proxy-stage rewards may mimic each evaluation criterion to generate scheduling policies. The proxy-stage rewards may be combined with tailored weights to approximate the overall evaluation metrics. The proxy-stage reward weights may be efficiently tuned for an RL agent by configuring the proxy-stage reward weights to maximize the final evaluation result. The ability to fine-tune the proxy-stage weights efficiently may improve scheduling outcomes.

Within a factory, a variety of policies (e.g., scheduling policies) may be in use. The scheduling policies may be tailored to different weighted proxy-reward functions, resulting in distinct final evaluation values for each scheduling policy. The final evaluation values may be enhanced by optimizing the weights assigned to proxy-stage reward functions. The ability to efficiently search for the optimal weight combinations as factory requirements evolve may enable improved scheduling performance.

The connection between evaluation targets and stage-proxy rewards may not always be clear, which may make determining proxy-stage weights that improve evaluation performance a complex task. The process of determining optimized proxy-stage reward weights (e.g., determining the weights assigned to stage rewards) may be resource-intensive and costly. Thus, an efficient approach to determining optimized proxy-stage weights may save resources and reduce costs.

In some embodiments, existing scheduling policies may be reused (e.g., efficiently reused), such that their associated weights may improve the process of determining optimized proxy-stage weights.

The above approaches improve on previous methods because they allow for efficient determination of improved scheduling policies that may be adapted to changing evaluation metrics for improving the performance of manufacturing systems. For example, determining an improved scheduling policy, which previously took about 100 hours (e.g., based on trial-and-error alone) may take 8 hours or less based on aspects of some embodiments of the present disclosure.

According to some embodiments of the present disclosure, a method for scheduling includes training a first scheduling policy based on a first weight and training a second scheduling policy based on a second weight that is different from the first weight, calculating a first evaluation result based on the first scheduling policy, calculating a second evaluation result based on the second scheduling policy, determining, by a processing circuit, a third scheduling policy based on inputting the first evaluation result and the second evaluation result into a policy-combination algorithm, calculating a third evaluation result based on the third scheduling policy, based on the third evaluation result, determining a third weight for the third scheduling policy by inverse reinforcement learning or by Bayesian optimization, training the third scheduling policy based on the third weight, and controlling a scheduling process based on the third scheduling policy.

The controlling the scheduling process based on the third scheduling policy may include one of changing an order of machine operations, selecting different navigation tasks, or changing an order of language model tasks.

The third weight may be determined based on inverse reinforcement learning based on the third evaluation result indicating the third evaluation result is greater than the first evaluation result and the second evaluation result.

The third weight may be determined based on Bayesian optimization based on the third evaluation result indicating the third evaluation result is less than or equal to the first evaluation result and the second evaluation result.

The policy-combination algorithm may includes at least one of a mixture-of-experts method, an adaptive-learning method, or a meta-learning method.

The determining the third weight based on inverse reinforcement learning or by Bayesian optimization may reduce a number of weight-combination trials for determining the third weight.

The first scheduling policy or the second scheduling policy may be determined based on inverse reinforcement learning or Bayesian optimization.

According to some embodiments of the present disclosure, a system for scheduling includes a processing circuit communicatively coupled with a machine, the processing circuit being configured to perform training a first scheduling policy based on a first weight and training a second scheduling policy based on a second weight that is different from the first weight, calculating a first evaluation result based on the first scheduling policy, calculating a second evaluation result based on the second scheduling policy, determining, by the processing circuit, a third scheduling policy based on inputting the first evaluation result and the second evaluation result into a policy-combination algorithm, calculating a third evaluation result based on the third scheduling policy, based on the third evaluation result, determining a third weight for the third scheduling policy by inverse reinforcement learning or by Bayesian optimization, training the third scheduling policy based on the third weight, and controlling a scheduling process based on the third scheduling policy.

The controlling the scheduling process based on the third scheduling policy may include one of changing an order of machine operations, selecting different navigation tasks, or changing an order of language model tasks.

The third weight may be determined based on inverse reinforcement learning based on the third evaluation result indicating the third evaluation result is greater than the first evaluation result and the second evaluation result.

The third weight may be determined based on Bayesian optimization based on the third evaluation result indicating the third evaluation result is less than or equal to the first evaluation result and the second evaluation result.

The policy-combination algorithm may include at least one of a mixture-of-experts method, an adaptive-learning method, or a meta-learning method.

The determining the third weight based on inverse reinforcement learning or by Bayesian optimization may reduce a number of weight-combination trials for determining the third weight, such that the third scheduling policy causes the system to satisfy a target evaluation metric.

The first scheduling policy or the second scheduling policy may be determined based on inverse reinforcement learning or Bayesian optimization.

According to some embodiments of the present disclosure, a system for scheduling includes a processing circuit and memory including instructions that, when executed by the processing circuit, cause the processing circuit to perform training a first scheduling policy based on a first weight and training a second scheduling policy based on a second weight that is different from the first weight, calculating a first evaluation result based on the first scheduling policy, calculating a second evaluation result based on the second scheduling policy, determining, by the processing circuit, a third scheduling policy based on inputting the first evaluation result and the second evaluation result into a policy-combination algorithm, calculating a third evaluation result based on the third scheduling policy, based on the third evaluation result, determining a third weight for the third scheduling policy by inverse reinforcement learning or by Bayesian optimization, training the third scheduling policy based on the third weight, and controlling a scheduling process based on the third scheduling policy.

The controlling the scheduling process based on the third scheduling policy may include one of changing an order of machine operations, selecting different navigation tasks, or changing an order of language model tasks.

The third weight may be determined based on inverse reinforcement learning based on the third evaluation result indicating the third evaluation result is greater than the first evaluation result and the second evaluation result.

The third weight may be determined based on Bayesian optimization based on the third evaluation result indicating the third evaluation result is less than or equal to the first evaluation result and the second evaluation result.

The determining the third weight based on inverse reinforcement learning or by Bayesian optimization may reduce a number of weight-combination trials for determining the third weight.

The first scheduling policy or the second scheduling policy may be determined based on inverse reinforcement learning or Bayesian optimization.

### BRIEF DESCRIPTION OF THE DRAWING

In the following section, the aspects of the subject matter disclosed herein will be described with reference to exemplary embodiments illustrated in the figures.

FIG. 1A is a system diagram depicting a system for manufacturing scheduling, according to some embodiments of the present disclosure.

FIG. 1B is a block diagram depicting a method for determining a new scheduling policy, according to some embodiments of the present disclosure.

FIG. 2 is a block diagram depicting an RL decision process associated with determining new scheduling policies, according to some embodiments of the present disclosure.

FIG. 3 is a table depicting examples of determining proxy stage rewards to achieve improved evaluation results, according to some embodiments of the present disclosure.

FIG. 4 is a flowchart depicting example operations of a method for scheduling, according to some embodiments of the present disclosure.

FIG. 5 is a block diagram of an electronic device in a network environment, according to some embodiments of the present disclosure.

FIG. 6 is a flowchart of a method of executing a schedule (e.g., a scheduling policy), according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “of” and “and/of” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

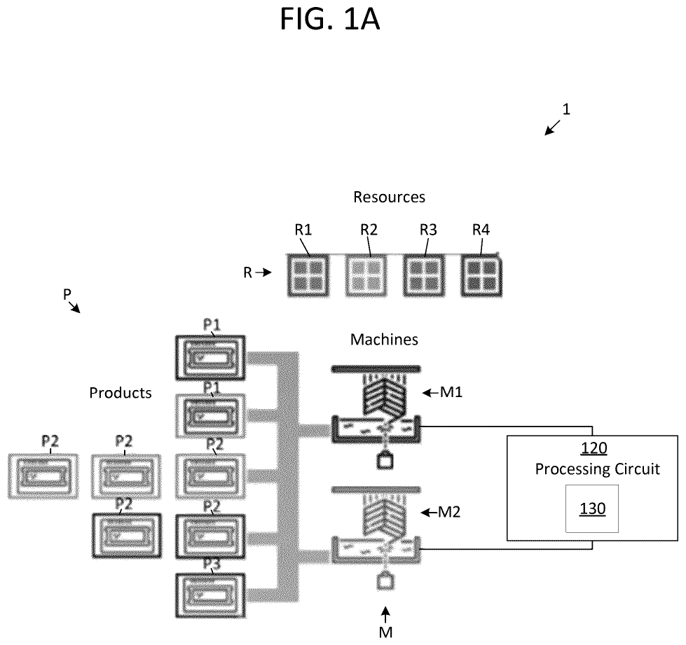

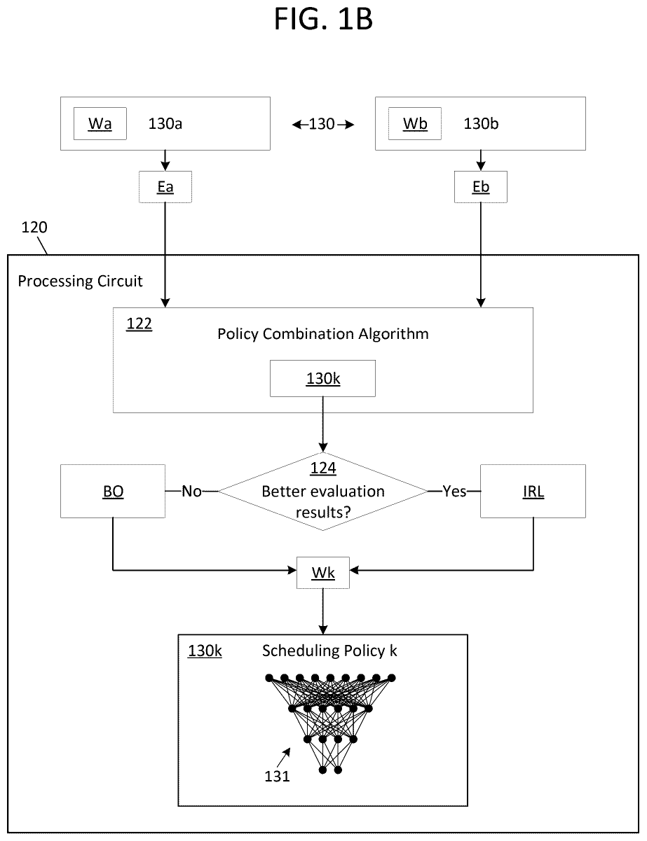

FIG. 1A is a system diagram depicting a system for manufacturing scheduling, according to some embodiments of the present disclosure.

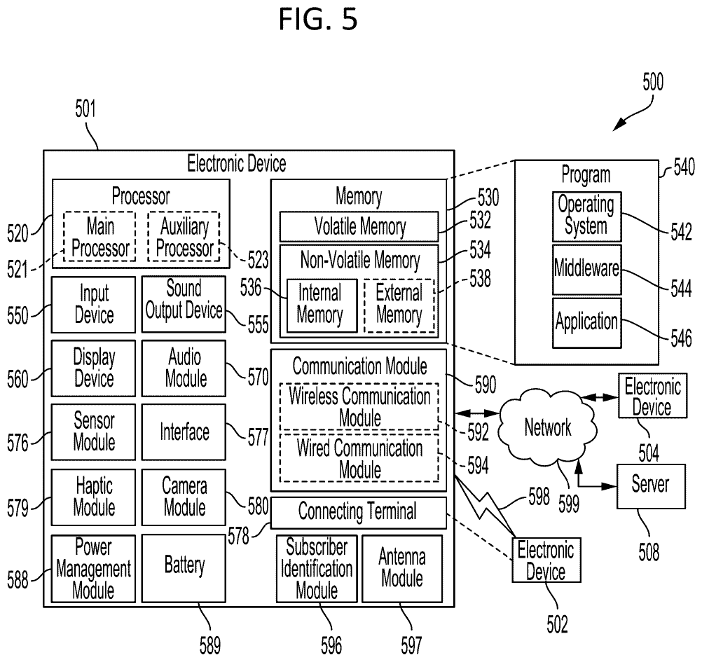

Referring to FIG. 1A, a system 1 (e.g., a manufacturing system) may include a processing circuit 120 (e.g., a processing circuit of the manufacturing system) for determining scheduling policies 130. As used herein, a “scheduling policy” refers to any model that receives information about jobs and/or machines for processing the jobs and that outputs a job to be processed. An example of a “scheduling policy” is a machine learning (ML) model. For example, each scheduling policy 130 may include an ML model. The ML model may be any ML model known to one of ordinary skill in the art. In some embodiments, the ML model may include a neural network 131. As used herein “training a scheduling policy” refers to adjusting parameters (e.g., weights) of the ML model. The processing circuit 120 may correspond to the processor 520 of FIG. 5. The system 1 may include machines M (e.g., manufacturing devices, including robots and/or the like), products P (e.g., jobs), and resources R. In some embodiments, the processing circuit 120 may be communicatively coupled to the machines M to implement the scheduling policies 130 and/or to observe results (e.g., performance results) associated with the scheduling policies 130. For example, the system 1 may include a first machine M1 and a second machine M2. The machines M may utilize the resources R to produce the products P. The products may include, for example, different types of display devices or different types of integrated circuits (ICs). The products may include a first type of product P1, a second type of product P2, and a third type of product P3. The resources R may include, for example, a mask (e.g., a semiconductor photomask) and/or materials for producing the products P. Although FIG. 1A depicts only a few machines, products, and resources, it should be understood that many (e.g., thousands of) machines and processes may be used per product in a typical manufacturing system.

The performance of the system 1 may be determined based on one or more performance criteria (e.g., performance metrics). For example, performance metrics may include targets (e.g., goals) for production capacity (e.g., a number of products produced per day), efficiency (e.g., power consumption, minimized downtime, etc.), time (e.g., on-time delivery), and/or the like. Some metrics may not be aligned with (e.g., may contradict) other metrics. For example, a first metric may include minimizing the number of jobs (e.g., products) in the system 1. Based on this first metric, the processing circuit 120 may generate a first scheduling policy 130 to prioritize making products P that are quicker to make over making products P that take a longer time to make. A second metric may include producing products P that would result in a maximum profit. Based on this second metric, the processing circuit 120 may generate a second scheduling policy 130 that prioritizes making more expensive and more complex products over making cheaper and less complex products. The first policy and the second policy may contradict each other if cheaper products are quicker to make than more expensive products. To find a satisfactory balance between the two policies based on their evaluation metrics, the two policies may be combined to generate a new policy having weights assigned, such that evaluation results may be improved.

FIG. 1B is a block diagram depicting a method for determining a new scheduling policy, according to some embodiments of the present disclosure.

Aspects of embodiments of the present disclosure allow a final reward-weight combination to be found that, when used in a new policy, achieves an evaluation result that is higher than all evaluation results of previous policies. Additionally, the final reward-weight combination may be found efficiently (e.g., without exploring all possible weight reward-weight combinations).

While embodiments of the present disclosure are described herein in the context of generating scheduling policies for coordinating various manufacturing processes and the like for system 1, the present disclosure is not limited thereto. For example, the systems and methods described herein may be applicable to any suitable systems and methods that may benefit from generating a new policy to achieve satisfactory results. In other words, as long as there is a policy that takes in some parameters/factors and outputs a decision/action, it can be used to generate a new policy according to one or more embodiments of the present disclosure. For example, the systems and methods described in more detail hereinafter may be applicable to various robotic control applications, navigation systems, autonomous driving applications, large language model training, and the like.

In some embodiments, multiple scheduling policies 130 may first be generated. For example, the multiple scheduling policies 130 may be generated based on trial and error, based on expert advice, and/or based on a previous iteration of reward weight optimization. For example, a previous iteration of reward weight optimization may include training a scheduling policy with a certain (e.g., a given) weighted combination of proxy stage rewards using RL. Reward weights (e.g., proxy stage reward weights) may be obtained based on the generated polices using inverse reinforcement learning (IRL). Given the reward weights, RL may be used to train scheduling policies on a CPU and/or a GPU. The inputs to the scheduling policies may be observations of (e.g., data associated with) products (e.g., jobs), machines, and/or resources. The outputs from the scheduling policies may be the jobs to process (e.g., a schedule of jobs to be processed). For example, a first-come-first-served scheduling policy may include the time of arrival of a product to the manufacturing system as an input, and the output of the scheduling policy may be an indication that a specific job with the longest waiting time in the manufacturing system is to be selected first for processing.

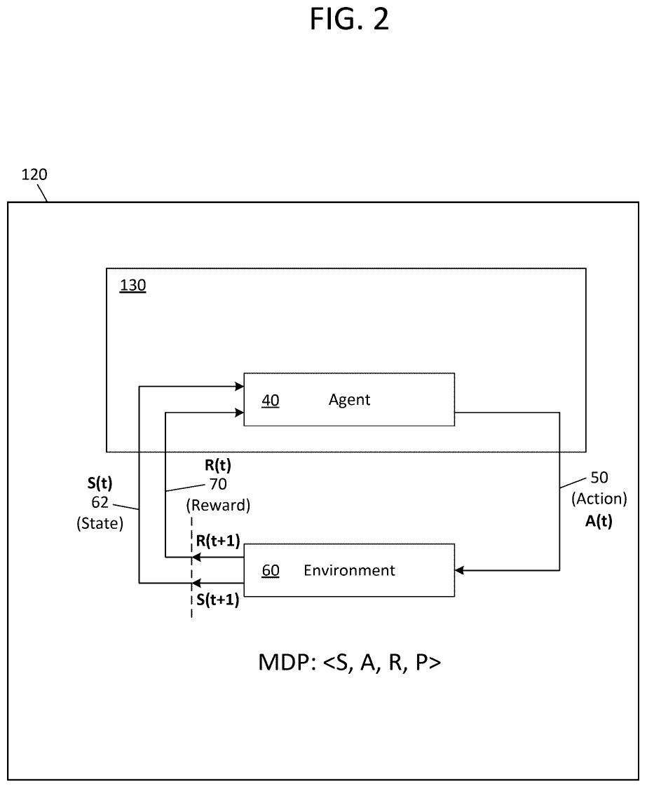

Based on a set of generated policies (e.g., a first scheduling policy 130a and a second scheduling policy 130b), the processing circuit 120 may generate a new scheduling policy 130k (e.g., a third scheduling policy) with a policy-combination algorithm 122 (e.g., a linear combination algorithm). To generate the new scheduling policy 130k, the policy combination algorithm 122 may receive a first evaluation result Ea from the first scheduling policy 130a as an input and may receive a second evaluation result Eb from the second scheduling policy 130b as an input. If the new scheduling policy 130k is evaluated (see operation 124) and determined to have a higher evaluation result than all previous evaluation results from previous scheduling policies 130, the processing circuit 120 may perform IRL to find the reward weights Wk of the new scheduling policy 130k. IRL generally refers to the process of inferring a reward weight (e.g., a reward function associated with reward weights) of an agent (see FIG. 2). In other words, IRL includes extracting (e.g., determining) a reward function by observing the behavior of an agent to rationalize the action of the agent based on the reward function. If the new scheduling policy 130k is evaluated (see operation 124) and does not achieve higher evaluation results than all previous evaluation results, the processing circuit 120 may perform Bayesian optimization BO, wherein a Gaussian process may be used to randomly sample new reward weights.

Although FIG. 1B depicts only a few scheduling policies 130 and a few weights W, it should be understood that many (e.g., thousands of) scheduling policies 130 and weights W may be involved in determining a new scheduling policy 130. For example, each scheduling policy 130 may be associated with many weights W.

In some embodiments, Bayesian optimization may be performed on a set of generated policies 130. Given the evaluation results of the generated policies 130, Bayesian optimization may be performed based on the weight set from the generated policies 130. A Bayesian optimizer may find the next reward weights that can maximize the evaluation results. The Bayesian optimizer may model the evaluation results as a Gaussian process, which is a type of machine learning (ML) model. The Bayesian optimizer may fit the Gaussian curve as accurately as possible to a reward weight curve (e.g., an unknown reward weight curve) by sampling through the evaluation results. The Bayesian optimizer may determine the next reward weights based on an uncertainty curve associated with the Gaussian curve and the evaluation results. Bayesian optimization may be thought of as a sequential design process for finding objective information (e.g., an objective function). Bayesian optimization may use a Gaussian process as a surrogate function of a probabilistic model of the objective function. Bayesian optimization may include iteratively sampling a next weight with an acquisition function and using the sampled weight for evaluation.

New reward weights may be iteratively added into a set of reward weights, new scheduling policies may be trained using RL, and the new scheduling policies may be evaluated to obtain new evaluation results. In this way, the evaluation results may be improved gradually until they converge to a satisfactory (e.g., to a target) evaluation result.

FIG. 2 is a block diagram depicting an RL decision process associated with determining new scheduling policies, according to some embodiments of the present disclosure.

Referring to FIG. 2, the processing circuit 120 may be configured to train scheduling policies 130 based on RL. As used herein, “reinforcement learning” (RL) refers to a machine-learning technique, where an agent 40 (e.g., a machine-learning model) takes an action 50 (e.g., makes an update to one or more weights associated with the machine-learning model) in an environment 60 to improve or maximize a reward 70. The action 50 may change a state 62 associated with the environment 60 to improve or increase the reward 70 achieved with respect to the state 62 (e.g., a previous state) of the system in association with the environment 60. Based on RL, the processing circuit 120 may discover the actions 50 that maximize the reward 70 associated with any given state 62.

The following discussion provides mathematical notation corresponding to the disclosure above related to FIG. 1B.

RL for improving scheduling policies 130 may be modeled as a Markov decision process (MDP) denoted as <S, A, R, P>, wherein an output scheduling policy 130 (or π) may be determined based on: a set of states 62 (e.g., environment-and-agent states S), a set of actions 50 (e.g., actions A of the agent 40), a probability P of transitioning from a first state s to a second state s′ under a given action α; and an immediate reward R_{α}(s, s′) after transitioning from the first state s to the second state s′ under the given action α.

A weighted summation of a set of evaluation metrics may be used to determine the quality of a given scheduling policy, as in Equation 1:

$$E = {\sum }_{i = 1 , . . , n} {α}_{i} {e}_{i} \qquad ( Eqn . 1 )$$

$$‖ α \cdot ‖ = 1$$

wherein E refers to the final evaluation result, αᵢ refers to the weight (e.g., the importance) of the i-th evaluation metric for the final evaluation result, eᵢ refers to a single evaluation metric for a given existing scheduling policy, ∥α·∥ refers to a norm (e.g., a normative vector) of a.

Evaluation metrics may not be modeled as a reward R to train RL agents directly because some of the evaluation metrics may only be determined after a period of time. That is, the evaluation metric e may not be determined immediately during execution of a given scheduling policy because several test runs may be needed before sufficient data is obtained through observation. For example, if a given evaluation metric includes producing a particular number of products per day. The number of products produced may not be available until after each eight-hour shift, which may be too long of a period of time to train an RL agent.

Referring below to Equation 2, to facilitate the learning of the RL agent toward a final evaluation E, domain experts may design various proxy stage rewards r (e.g., immediate rewards) to approximate a given single evaluation metric eᵢ.

$${R}_{k} = {\sum }_{i = 1 , . . , n} {β}_{i , k} {r}_{i} \qquad ( Eqn . 2 )$$

$$‖ {β}_{\cdot , k} ‖ = 1$$

wherein k refers to the k-th MDP environment with <S, A, Rₖ, P>, Rₖ refers to the k-th MDP reward, which is a summation of each stage reward (e.g., each immediate reward rᵢ), β_{i,k} refers to the weight (e.g., the importance of the i-th evaluation metric for the final evaluation result of the k-th MDP environment, ∥β·;ₖ∥ refers to the k-th MDP reward weight's norm. β is the coefficient for each stage reward (e.g., each immediate reward).

Referring below to Equation 3, a set of immediate rewards Rₖ may be determined (e.g., obtained) by sampling βₖ.

$$< S , A , {R}_{k} , P > ⇒ {π}_{k} , k ∈ \{ 1 , … , K \} \qquad ( Eqn . 3 )$$

S refers to a given state, A refers to a given agent action, P refers to a probability of changing from one state to another state, πₖ refers to a k-th policy determined from a k-th weight set of βₖ, K refers to the total number of MDP environments, k ϵ{1, . . . , K} refers to an index for a given MDP environment, and ⇒πₖ, k ϵ{1, . . . , K} refers to obtaining the k-th policy.

Given a set of scheduling policies trained from the immediate rewards Rₖ:

$${\{ < S , A , {R}_{k} , P > , {π}_{k} , {β}_{\cdot , k} \}}_{k = 1 , … , K} \qquad ( Eqn . 4 )$$

the weight β of each proxy stage reward rᵢ may be found, such that:

$${E}_{β} > max ( {\{ {E}_{{β}_{\cdot , k}} \}}_{k = 1 , … , K} ) \qquad ( Eqn . 5 )$$

wherein E_{β} refers to the final evaluation result, given the policy π trained on <S, A, R_{β}, P>, where R_{β}=Σ_{i=1, . . . , n} βrᵢ.

Multiple scheduling policies may be generated by: sampling K sets of weights βᵢ to determine the reward Rₖ=Σ_{i,k}rᵢ, training the k-th MDP<S,A, Rₖ, P>⇒πₖ, k ϵ{1, . . . , K}, and determining the policy irk that is optimized toward the reward Rₖ. The final evaluation result {Eₖ}_{k=1, . . . , K} may be obtained by evaluating the policies {πₖ}_{k=1, . . . , K} on E.

In some embodiments, scheduling policies may be improved using Bayesian optimization (BO). Bayesian optimization generally refers to improving a function (e.g., a scheduling policy) using past performances. For example, to find a next β that improves (e.g., maximizes) the evaluation result E, Bayesian optimization may be performed using the weight set {β·,ₖ, Eₖ}_{k=1, . . . , K}, wherein β=BO({β·ₖ, Eₖ}_{k=1, . . . , K}), wherein BO refers to the Bayesian optimization method that is to sample the next β that can lead to a higher evaluation result E.

Proxy stage reward weights β may be generated by generating new scheduling policies by combining the k-th policies πₖ, such that a new policy π*=ƒ(π_{k=1, . . . , K}), wherein ƒ(π_{k=1, . . . , K}) refers to a policy combination method. The policy combination method f may be any existing policy combination method known to one of ordinary skill in the art. For example, the policy combination method may include a mixture-of-experts method, an adaptive-learning method, a meta-learning method, and/or the like.

The new scheduling policy π* may be evaluated for a new evaluation result E*. If the new evaluation result E* is better than previous evaluation results (E*>{Eₖ}_{k=1, . . . , K}), then inverse RL may be performed using a feature-based reward function to find β. For example:

$${min}_{β} {‖ β ‖}_{2}^{2} \qquad ( Eqn . 6 - 1 )$$

such that

$$E [ \sum R * \vert π * ] \geq E [ \sum R * \vert π ] ∀ π \qquad ( Eqn . 6 - 2 )$$

wherein

$$R *= β * {r}_{i} ( π ) \qquad ( Eqn . 6 - 3 )$$

wherein min_{β}∥β∥₂² refers to minimizing the norm of β, E[ΣR*|π*] refers to the expectation of the total reward that the new scheduling policy π* can achieve (e.g., the total reward for executing the new scheduling policy π*), E[ΣR*|π]∀π refers to the expectation of the total reward obtained by any policy π previously obtained, and R* refers to the new state reward with the new reward coefficient β*. For equations 6-2 and 6-3 above, the policy π may be set such that

$$π = \frac{1}{K} {\sum }_{k = 1 , … , K} {γ}_{k} {π}_{k} ,$$

wherein the first K obtained is determined by training a model with randomly sampled γₖ, wherein γₖ refers to the weight of each different policy.

If E*≤{Eₖ}_{k=1, . . . , K}, then a new β may be randomly sampled by using a Gaussian process. The Gaussian process is a part of Bayesian optimization. The Gaussian process may be used to determine a range of outputs associated with estimated mean values and estimated uncertainties. In some embodiments, Gaussian optimization may be used to assume the value for β of each proxy stage reward r.

Scheduling policies may be improved based on an iterative process of finding new values for proxy stage reward weights β that improve the evaluation results. For example, the iterative process may include adding a new proxy stage reward weight β into the set {βₖ}_{k=1, . . . , K} as β_{K+1}, training the k+1-th MDP<S, A, R_{K+1}, P>⇒π_{K+1}, and evaluating the k+1-th policy π_{K+1} to obtain the k+1-th evaluation results E_{K+1}.

In summary, a process for improving scheduling policies may include, at an initialization stage of the process, selecting a prior function ƒ (e.g., a Gaussian process) for BO, updating the function ƒ from the existing K policies and β, and setting n to zero, wherein n refers to a given iteration number. Based on results of the initial stage, and while n is less than the maximum number of iterations N (before E_{β} and π_{β} converge), determining the next proxy stage reward weight β by observing the new sample of β, E, updating the posterior distribution on the function ƒ using all samples, and incrementing the iteration number n (e.g., to n+1).

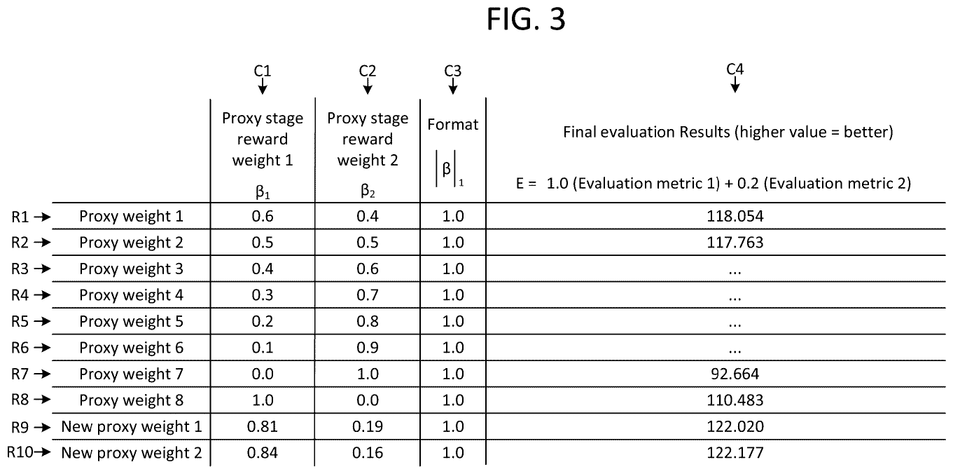

FIG. 3 is a table depicting examples of determining proxy stage rewards to achieve improved evaluation results, according to some embodiments of the present disclosure.

Referring to FIG. 3, the values of column C1 refer to a first proxy stage reward weight β₁ and the values of column C2 refer to a second proxy stage reward weight β₂. The values of column C1 and column C2 in each row (e.g., R1 through R10) add up to the value of column C3, which refers to the sum of the proxy stage reward weights. Column C4 refers to the final evaluation results based on overall evaluation metrics. For example, the overall evaluation metric may be equal to 1.0 times a first evaluation metric plus 0.2 times a second evaluation metric. Each combination of proxy-stage reward weights may result in different final evaluation results, wherein a higher evaluation result indicates a better evaluation result. The values of columns C1 and C2 in rows R1 through R8 were determined by merely exploring eight values in a range from 0.0 to 1.0 (e.g., at random), while the values of columns C1 and C2 in rows R9 and R10 were determined based on embodiments of the present disclosure. With only two iterations, the methods of the present disclosure were able to find proxy stage reward weights achieving higher evaluation results than any previous combination of proxy stage reward weights. Thus, aspects of embodiments of the present disclosure provide methods and systems for maximizing evaluation results, while minimizing the number of weight-combination trials.

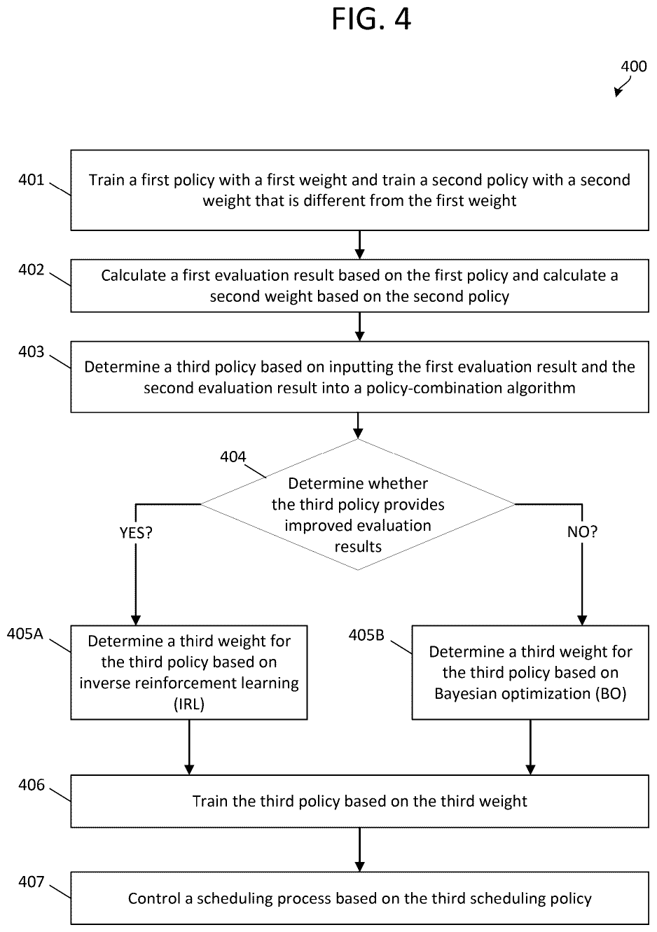

FIG. 4 is a flowchart depicting example operations of a method for scheduling, according to some embodiments of the present disclosure.

Referring to FIG. 4, a method 400 for scheduling (e.g., a weight-optimization process for determining improved scheduling policies) may include one or more of the following operations. A processing circuit 120 (see FIGS. 1A and 1B) may train a first scheduling policy 130a with a first weight Wa and train a second scheduling policy 130b with a second weight Wb (operation 401). The processing circuit 120 may calculate a first evaluation result Ea based on the first policy 130a and calculate a second evaluation result Eb based on the second policy 130b (operation 402). The processing circuit 120 may determine a third scheduling policy 130k based on inputting the first evaluation result Ea and the second evaluation result Eb into a policy-combination algorithm 122 (operation 403). The processing circuit 120 may determine whether the third scheduling policy 130k provides improved evaluation results over all previous scheduling policies (operation 404). Based on determining that the third scheduling policy 130k provides improved evaluation results over all previous scheduling policies (e.g., including the first scheduling policy 130a and the second scheduling policy 130b), the processing circuit 120 may determine a third weight Wk based on IRL (operation 405A). Based on determining that the third scheduling policy 130k does not provide improved evaluation results over all previous scheduling policies (e.g., including the first scheduling policy 130a and the second scheduling policy 130b), the processing circuit 120 may determine a third weight Wk based on Bayesian optimization (operation 405B). The processing circuit 120 may train the third scheduling policy 130k using the third weight Wk (operation 406). The processing circuit 120 may control a scheduling process based on the third scheduling policy 130k (operation 407). For example, the processing circuit 120 may cause the system 1 (see FIG. 1A) to produce a product P based on (e.g., using) the third scheduling policy 130k. For example, the product P may be produced more efficiently (e.g., in less time, with fewer resources, and/or with lower power consumption) based on the third scheduling policy 130k than based on the first scheduling policy 130a or the second scheduling policy 130b.

In some embodiments, instead of producing the product P, the third scheduling policy 130k may be executed to coordinate other machine actions in a factory, schedule navigation tasks, coordinate language model tasks, and/or the like. For example, executing the third scheduling policy 130k, and controlling a scheduling process, may include changing the order of machine operations, selecting different navigation tasks, changing an order of language model tasks, and/or the like, based on the third scheduling policy 130k schedule.

The first scheduling policy 130a and the second scheduling policy 130b may refer to policies determined based on an initial trial-and-error process or may refer to policies determined in a previous iteration of the weight-optimization process. For example, the third scheduling policy 130k may be determined as part of iteration n+1, with the first scheduling policy 130a and/or the second scheduling policy 130b determined as part of iteration n.

The method 400 may be performed on one or more components of the electronic device 501 of FIG. 5. For example, one or more operations may be performed using a combination of software components and hardware components corresponding to the processor 520 and the memory 530 of FIG. 5.

FIG. 5 is a block diagram of an electronic device in a network environment 500, according to some embodiments of the present disclosure.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or the server 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

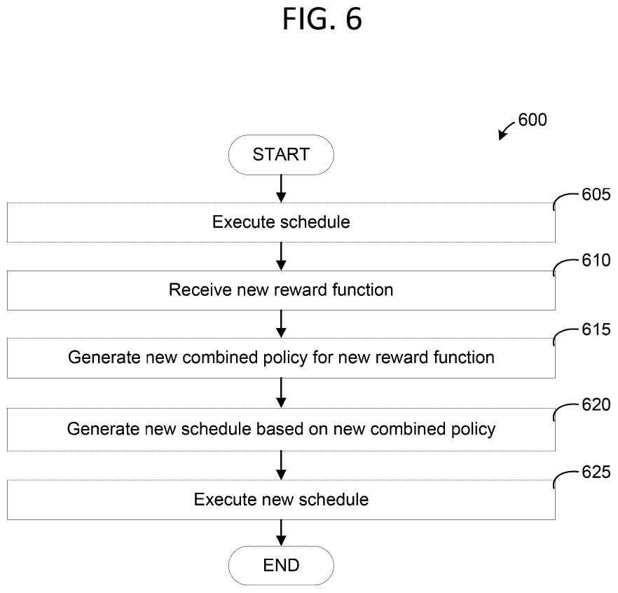

FIG. 6 is a flowchart of a method of executing a schedule (e.g., a scheduling policy), according to some embodiments of the present disclosure.

The method 600 shown in FIG. 6, may be performed, for example, by the processing circuit 120 described above with reference to FIGS. 1A-2. However, the present disclosure is not limited thereto, and the operations shown in the method 600 may be performed by any suitable one of the components and elements or any suitable combination of the components and elements of those of one or more example embodiments described above. Further, the present disclosure is not limited to the sequence or number of the operations of the method 600 shown in FIG. 6, and can be altered into any desired sequence or number of operations as recognized by a person having ordinary skill in the art. For example, in some embodiments, the order may vary, or the method 600 may include fewer or additional operations. Further, the operations shown in method 600 may be performed sequentially, or at least some of the operations thereof may be performed concurrently (e.g., simultaneously, or substantially simultaneously).

Referring to FIG. 6, the method 600 may start, and a schedule (e.g., a scheduling policy) may be executed (operation 605). For example, in some embodiments, the schedule may be executed to coordinate machine actions in a factory, schedule navigation tasks, coordinate language model tasks, and the like.

A reward function (e.g., a new reward function) may be generated (e.g., received) (operation 610). For example, in some embodiments, a new reward function corresponding to evaluation results (e.g., evaluation metrics) for the generated schedules may be received (e.g., from a domain expert and the like) (operation 610).

A new combined policy (e.g., scheduling policy) may be generated for the new reward function (operation 615). For example, the new combined policy may be generated for the new reward function as a parameterized (e.g., a weighted) combination of a plurality of existing policies based on the new reward function and the evaluation results as discussed above with reference to FIGS. 1B and 4. As a result, a new schedule may be generated based on the new combined policy (operation 620).

The new schedule may be executed (operation 625), and the method 600 may end. For example, executing the new schedule may include changing the order of machine operations, selecting different navigation tasks, changing an order of language model tasks, and the like, based on the new schedule.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for scheduling, the method comprising:
training a first scheduling policy based on a first weight and training a second scheduling policy based on a second weight that is different from the first weight;
calculating a first evaluation result based on the first scheduling policy;
calculating a second evaluation result based on the second scheduling policy;
determining, by a processing circuit, a third scheduling policy based on inputting the first evaluation result and the second evaluation result into a policy-combination algorithm;
calculating a third evaluation result based on the third scheduling policy;
based on the third evaluation result, determining a third weight for the third scheduling policy by inverse reinforcement learning or by Bayesian optimization;
training the third scheduling policy based on the third weight; and
controlling a scheduling process based on the third scheduling policy.

2. The method of claim 1, wherein the controlling the scheduling process based on the third scheduling policy comprises one of changing an order of machine operations, selecting different navigation tasks, or changing an order of language model tasks.

3. The method of claim 1, wherein the third weight is determined based on inverse reinforcement learning based on the third evaluation result indicating the third evaluation result is greater than the first evaluation result and the second evaluation result.

4. The method of claim 1, wherein the third weight is determined based on Bayesian optimization based on the third evaluation result indicating the third evaluation result is less than or equal to the first evaluation result and the second evaluation result.

5. The method of claim 1, wherein the policy-combination algorithm comprises at least one of a mixture-of-experts method, an adaptive-learning method, or a meta-learning method.

6. The method of claim 1, wherein determining the third weight based on inverse reinforcement learning or by Bayesian optimization reduces a number of weight-combination trials for determining the third weight.

7. The method of claim 1, wherein the first scheduling policy or the second scheduling policy are determined based on inverse reinforcement learning or Bayesian optimization.

8. A system for scheduling, the system comprising:
a processing circuit communicatively coupled with a machine, the processing circuit being configured to perform:
training a first scheduling policy based on a first weight and training a second scheduling policy based on a second weight that is different from the first weight;
calculating a first evaluation result based on the first scheduling policy;
calculating a second evaluation result based on the second scheduling policy;
determining, by the processing circuit, a third scheduling policy based on inputting the first evaluation result and the second evaluation result into a policy-combination algorithm;
calculating a third evaluation result based on the third scheduling policy;
based on the third evaluation result, determining a third weight for the third scheduling policy by inverse reinforcement learning or by Bayesian optimization;
training the third scheduling policy based on the third weight; and
controlling a scheduling process based on the third scheduling policy.

9. The system of claim 8, wherein the controlling the scheduling process based on the third scheduling policy comprises one of changing an order of machine operations, selecting different navigation tasks, or changing an order of language model tasks.

10. The system of claim 8, wherein the third weight is determined based on inverse reinforcement learning based on the third evaluation result indicating the third evaluation result is greater than the first evaluation result and the second evaluation result.

11. The system of claim 8, wherein the third weight is determined based on Bayesian optimization based on the third evaluation result indicating the third evaluation result is less than or equal to the first evaluation result and the second evaluation result.

12. The system of claim 8, wherein the policy-combination algorithm comprises at least one of a mixture-of-experts method, an adaptive-learning method, or a meta-learning method.

13. The system of claim 8, wherein determining the third weight based on inverse reinforcement learning or by Bayesian optimization reduces a number of weight-combination trials for determining the third weight, such that the third scheduling policy causes the system to satisfy a target evaluation metric.

14. The system of claim 8, wherein the first scheduling policy or the second scheduling policy are determined based on inverse reinforcement learning or Bayesian optimization.

15. A system for scheduling, the system comprising:
a processing circuit and memory comprising instructions that, when executed by the processing circuit, cause the processing circuit to perform:
training a first scheduling policy based on a first weight and training a second scheduling policy based on a second weight that is different from the first weight;
calculating a first evaluation result based on the first scheduling policy;
calculating a second evaluation result based on the second scheduling policy;
determining, by the processing circuit, a third scheduling policy based on inputting the first evaluation result and the second evaluation result into a policy-combination algorithm;
calculating a third evaluation result based on the third scheduling policy;
based on the third evaluation result, determining a third weight for the third scheduling policy by inverse reinforcement learning or by Bayesian optimization;
training the third scheduling policy based on the third weight; and
controlling a scheduling process based on the third scheduling policy.

16. The system of claim 15, wherein the controlling the scheduling process based on the third scheduling policy comprises one of changing an order of machine operations, selecting different navigation tasks, or changing an order of language model tasks.

17. The system of claim 15, wherein the third weight is determined based on inverse reinforcement learning based on the third evaluation result indicating the third evaluation result is greater than the first evaluation result and the second evaluation result.

18. The system of claim 15, wherein the third weight is determined based on Bayesian optimization based on the third evaluation result indicating the third evaluation result is less than or equal to the first evaluation result and the second evaluation result.

19. The system of claim 15, wherein determining the third weight based on inverse reinforcement learning or by Bayesian optimization reduces a number of weight-combination trials for determining the third weight.

20. The system of claim 15, wherein the first scheduling policy or the second scheduling policy are determined based on inverse reinforcement learning or Bayesian optimization.
